(19) United States
(12) Patent Application Publication
(10) Pub. No.: US 2026/0158810 A1
(43) Pub. Date: Jun. 11, 2026

(54) PRINT SETTING METHOD AND PRINTING APPARATUS

(71) Applicant: SHARP KABUSHIKI KAISHA, Sakai City (JP)

(72) Inventor: Yuhko KANEMOTO, Sakai City (JP)

(21) Appl. No.: 19/407,279

(22) Filed: Dec. 3, 2025

(30) Foreign Application Priority Data
Dec. 5, 2024 (JP) 2024-212341

(51) Int. Cl. B42C 1/12; G03G 15/00

(52) U.S. Cl. CPC B42C 1/12; G03G 15/6544; G03G 2215/00827; G03G 2215/00936

(57) ABSTRACT

A print setting method for a processing apparatus that performs stapling processing for one or more printouts, comprises (a) receiving a designation of the stapling processing for the one or more printouts; and (b) outputting, in a case where a division designation to divide and bind the one or more printouts in step (a) is received, the one or more printouts using a division unit according to the division designation received.

### CROSS-REFERENCE TO RELATED APPLICATION

The present application claims priority from Japanese Application JP2024-212341, the content of which is hereby incorporated by reference into this application.

### BACKGROUND

### 1. Field

The disclosure relates to a print setting method and the like.

### 2. Description of the Related Art

A document processing system is known in which setting to staple a document using a chapter unit can be performed, in addition to setting to staple an entire document as a whole.

### SUMMARY

One of the objects of the disclosure is to provide a print setting method and the like capable of improving convenience for a user when printouts are divided and stapled.

In order to solve the above-described problems, a print setting method according to the disclosure is a print setting method for a processing apparatus that performs stapling processing for one or more printouts, the print setting method including (a) receiving a designation of the stapling processing for the one or more printouts, and (b) outputting, in a case where a division designation to divide and bind the one or more printouts in step (a) is received, the one or more printouts using a division unit according to the division designation received.

Additionally, a printing apparatus according to the disclosure is a printing apparatus that outputs one or more printouts based on a print setting received via a driver program of a terminal device, the printing apparatus including one or more controllers that receive a designation of stapling processing for the one or more printouts included in the print setting, and a printer, wherein in a case of receiving a division designation to divide and bind the one or more printouts, the one or more controllers cause the printer to output the one or more printouts using a division unit according to the division designation received.

Further, a printing apparatus according to the disclosure includes one or more controllers that receive a designation of stapling processing for one or more printouts, and a printer, wherein in a case of receiving a division designation to divide and bind the one or more printouts, the one or more controllers cause the printer to output the one or more printouts using a division unit according to the division designation received.

According to the disclosure, it is possible to provide a print setting method and the like capable of improving convenience for a user when one or more printouts are divided and stapled.

### BRIEF DESCRIPTION OF THE DRAWINGS

FIG. 1 is a diagram for explaining an example of a connection mode of a terminal device with respect to a printing apparatus according to a first embodiment.

FIG. 2 is an external perspective view for explaining an appearance of the printing apparatus according to the first embodiment.

FIG. 3 is a diagram for explaining a functional configuration of the printing apparatus according to the first embodiment.

FIG. 4 is a diagram for explaining a functional configuration of the terminal device according to the first embodiment.

FIG. 5 is a flowchart for explaining a flow of processing according to the first embodiment.

FIGS. 6A, 6B, 6C, and 6D are diagrams for explaining operation examples according to the first embodiment.

FIGS. 7A, 7B, 7C, and 7D are diagrams for explaining operation examples according to the first embodiment.

FIG. 8 is a flowchart for explaining a flow of processing according to a second embodiment.

FIGS. 9A, 9B, and 9C are diagrams for explaining operation examples according to the second embodiment.

FIG. 10 is a flowchart for explaining a flow of processing according to a third embodiment.

FIGS. 11A and 11B are diagrams for explaining operation examples according to the third embodiment.

FIGS. 12A, 12B, and 12C are diagrams for explaining operation examples according to the third embodiment.

FIGS. 13A, 13B, and 13C are diagrams for explaining operation examples according to the third embodiment.

FIG. 14 is a flowchart for explaining a flow of processing according to a fourth embodiment.

FIGS. 15A and 15B are diagrams for explaining operation examples according to the fourth embodiment.

FIG. 16 is a flowchart for explaining a flow of processing according to a fifth embodiment.

FIGS. 17A and 17B are diagrams for explaining operation examples according to the fifth embodiment.

FIGS. 18A and 18B are diagrams for explaining configuration examples of a print setting screen according to the related art.

### DESCRIPTION OF EMBODIMENTS

Hereinafter, embodiments of the disclosure will be described with reference to the drawings. The disclosure describes a multifunction peripheral, as one form of a printing apparatus which functions as a processing apparatus to which a print setting method according to the disclosure is applied, that is capable of enabling jobs related to, for example, copying, printing, scanning, faxing, e-mail transmission, and the like in one housing. Note that the printing apparatus according to the disclosure is not limited in configuration as long as the printing apparatus is configured to be capable of stapling printouts output based on the print setting method according to the disclosure. Note that the following embodiments are examples for explaining the disclosure, and the technical contents of the disclosure described in the claims are not limited to the following description. Incidentally, in the disclosure, an output product obtained by outputting a document including information such as characters and images as a print image on a recording medium such as a sheet is referred to as a printout.

Stapling processing is known as a function of post-processing for printouts output based on a print job. The stapling processing is a function of stacking a plurality of printouts and binding the plurality of printouts with a stapler or the like to create a bundle of the printouts (booklets).

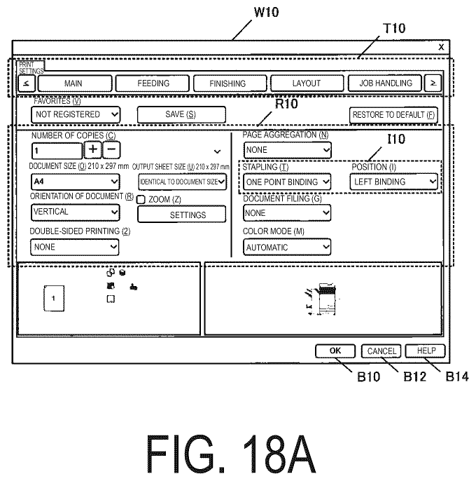

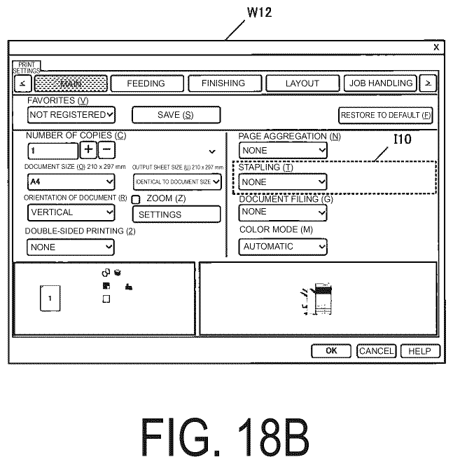

Here, a configuration example of a print setting screen W10 (W12) to receive setting of stapling processing according to the related art will be described with reference to FIGS. 18A and 18B. FIG. 18A illustrates the print setting screen W10 when the stapling processing is set to be enabled by a user, and FIG. 18B illustrates the print setting screen W12 when the stapling processing is set to be disabled by the user.

The print setting screen W10 (W12) illustrated in FIGS. 18A and 18B includes a PRINT SETTING tab T10, a print setting area R10, an OK button B10, a CANCEL button B12, and a HELP button B14 as screen components. The PRINT SETTING tab T10 is provided with tabs such as “MAIN”, “PAPER FEED”, “FINISH”, “LAYOUT”, and “JOB HANDLING” that can be selected by the user. The user can display desired print setting items by selecting any tab provided in the PRINT SETTING tab T10.

The print setting area R10 is an area to display print setting items included in the “MAIN” tab provided in the PRINT SETTING tab T10. In the print setting area R10 illustrated in FIGS. 18A and 18B, a “NUMBER OF COPIES” item, a “DOCUMENT SIZE” item, an “OUTPUT SHEET SIZE” item, an “ORIENTATION OF DOCUMENT” item, a “ZOOM” item, a “DOUBLE-SIDED PRINTING” item, a “PAGE AGGREGATION” item, a “STAPLING” item I10, a “DOCUMENT FILING” item, and a “COLOR MODE” item are displayed as the print setting items. The user can select or input a desired setting value (parameter) in each of the print setting items displayed in the print setting area R10.

The OK button B10 is a selection button to receive a confirmation instruction of a print setting via the print setting screen W10 (W12). The CANCEL button B12 is a selection button to receive a cancel instruction of a print setting via the print setting screen W10 (W12). The HELP button B14 is a selection button to receive an instruction to display an explanation about the print settings via the print setting screen W10 (W12), and a performance instruction of an input support function or the like to promote print setting.

Here, the “STAPLING” item I10 included in the print setting area R10 is a print setting item to receive selection of setting values (parameters) related to a stapling function. FIG. 18A illustrates that a “ONE POINT BINDING” as a type of stapling and “LEFT BINDING” as a stapling position are each selected via a pull-down menu, and the stapling processing is set to be enabled.

On the other hand, FIG. 18B illustrates a setting state of the “STAPLING” item I10 when the stapling processing is not selected by the user. In the illustration, “NONE” is selected in the “STAPLING” item I10, and the stapling processing is set to be disabled.

Incidentally, regarding the stapling processing, a function is known that, when printouts are formed so as to be divided by chapters, creates a plurality of booklets by binding the printouts divided using a chapter unit. Note that in the disclosure, operation or an aspect of dividing printouts into bundles (of the printouts) based on a predetermined rule is referred to as “division”.

However, as illustrated in FIGS. 18A and 18B, in the related art, the setting of the stapling processing is only enabled or disabled based on the setting of the type of stapling or the position of stapling, and the function of dividing and binding the printouts is only used in a limited manner such as the division using the chapter unit, and it is difficult to say that the function is highly convenient for the user.

In the disclosure, a print setting method and the like capable of improving convenience for a user when printouts are divided and stapled are enabled in the following embodiments.

### 1. First Embodiment

### 1.1 Overall Configuration

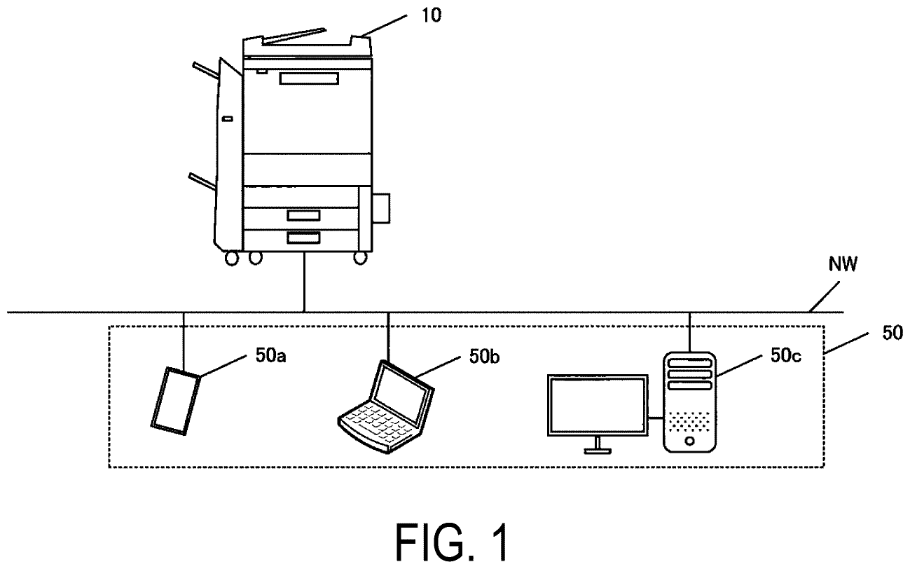

FIG. 1 is a diagram for explaining an example of a connection mode of a terminal device 50 with respect to a multifunction peripheral 10 as a printing apparatus according to a first embodiment. The multifunction peripheral 10 and the terminal device 50 (50a, 50b, or 50c) are formed to be capable of communicating with each other via a network NW. Here, examples of the network NW include a Local Area Network (LAN), a Wide Area Network (WAN), and the Internet. Note that in the following description, the print setting method according to the disclosure is applied to a mode in which application data created via a text creation application, a diagram creation application, or the like included in the terminal device 50 (50a, 50b, or 50c) is printed and output by the multifunction peripheral 10 via a printer driver for description, but the print setting method according to the disclosure can be applied to document printing based on image data input via an image inputter described below via a built-in application implemented in the multifunction peripheral 10.

### 1.2 Regarding Multifunction Peripheral 10

### 1.2.1 Functional Configuration

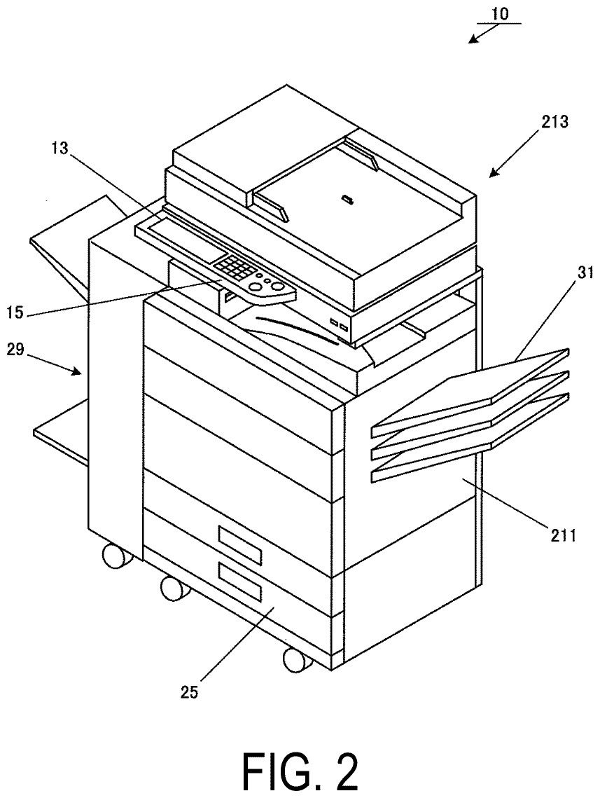

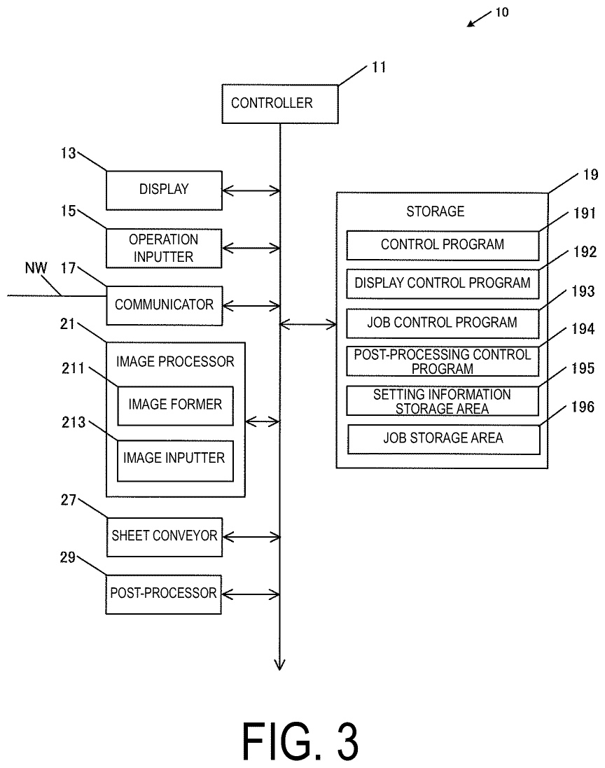

FIG. 2 is an external perspective view for explaining an appearance of the multifunction peripheral 10. FIG. 3 is a functional configuration diagram of the multifunction peripheral 10.

The multifunction peripheral 10 includes a controller 11, a display 13, an operation inputter 15, a communicator 17, a storage 19, an image processor 21, a sheet conveyor 27, and a post-processor 29.

The controller 11 generally controls the multifunction peripheral 10. The controller 11 can include one or more processing apparatuses (for example, a Central Processing Unit (CPU), a System on Chip (SoC), or the like). The controller 11 enables functions thereof by reading and executing various programs stored in the storage 19. Note that the controller 11 may be formed of one or more control circuits.

The display 13 displays various types of information to the user. The display 13 can be formed of, for example, a Liquid Crystal Display (LCD) or an organic Electro-Luminescence (EL) display, or the like. The display 13 displays an operation screen (for example, a home screen (not illustrated), a setting screen, or an execution screen related to setting and execution of each job) depending on a state of the multifunction peripheral 10, a notification screen including a warning described below, and the like.

The operation inputter 15 receives information input from the user, or the like. The operation inputter 15 can be formed of, for example, various input devices such as operation keys such as hard keys and software keys, and buttons. The operation inputter 15 can also be formed as a touch panel that allows information to be input via the display 13. When the operation inputter 15 is formed as a touch panel, the operation inputter 15 can detect a user's touch, tap, or swipe operation or the like with respect to an object such as an operation key and an operation button displayed via the display 13, and acquire coordinate information, pressure-sensitive information, or the like on the touch panel. As an input scheme for a touch panel, for example, a general scheme such as a resistive film scheme, an infrared scheme, an electromagnetic induction scheme, or a capacitive scheme can be employed.

The communicator 17 includes, for example, one or both of wired and wireless interfaces for communicating with other devices (the terminal device 50, and the like) via the network (NW) such as a LAN, a WAN, the Internet, a telephone line, or a fax line. Further, the communicator 17 may include an interface related to (short-range) wireless communication technology, such as Bluetooth (registered trademark), Near Field Communication (NFC), Wi-Fi (registered trademark), ZigBee (registered trademark), Infrared Data Association (IrDA), or wireless USB.

The image processor 21 includes an image former 211 as a printer and an image inputter 213. The image former 211 forms a print image based on image data input from the image inputter 213 on a sheet as a medium fed from a feed tray 25. A printout on which a print image is formed is then discharged to a sheet discharge tray 31 by the sheet conveyor 27. Note that when post-processing such as stapling is set for printouts to be output via a setting screen described below, the sheet conveyor 27 conveys the printouts to the post-processor 29. Note that the image former 211 can be formed of, for example, a laser printer that employs an electrophotographic scheme or the like. In this case, the image former 211 performs image formation using toners supplied from toner cartridges (not illustrated) corresponding to toner colors (for example, cyan, magenta, yellow, and black).

The image inputter 213 can be formed as a scanner device including an Automatic Document Feeder (ADF), a flatbed for placing and reading a document, and the like, in addition to an image sensor such as a Charge Coupled Device (CCD) or a Contact Image Sensor (CIS). The configuration of the image inputter 213 is not particularly limited as long as the image inputter 213 is capable of generating image data by reading reflected light from a document image with an image sensor. Note that the image inputter 213 can also be formed as an interface capable of acquiring image data stored in a storage device such as a USB memory and having a file format such as TIFF, BMP, or JPEG, or image data transmitted from the terminal device 50, for example. Incidentally, the image inputter 213 may be a form that generates image data for data transmission by performing, for example, shading correction or density correction on acquired image data.

The sheet conveyor 27 includes sheet conveyance members such as a conveying roller that holds and conveys a sheet (printout), a registration roller that forcibly skews the sheet (printout), and a conveying path switching device, and conveys the sheet (printout) to a predetermined transit point (for example, the image former 211) or a destination (for example, the post-processor 29 or the like) via a sheet conveying path (not illustrated) formed in the multifunction peripheral 10.

The post-processor 29 is a functional unit that performs post-processing such as stapling for output printouts. The post-processor 29 includes, for example, a stapling device such as a stapler for binding a plurality of printouts, a moving device to move the printouts to an appropriate stapling position (post-processing position), a conveying device to feed the printouts after the post-processing to the sheet discharge tray, and the like.

The storage 19 is one or more storage devices that store various programs and various types of data required for the operation of the multifunction peripheral 10. The storage 19 can include a storage device such as a Random Access Memory (RAM), a Solid State Drive (SSD), a Hard Disk Drive (HDD), and a Read Only Memory (ROM).

In the first embodiment, the storage 19 stores a control program 191, a display control program 192, a job control program 193, and a post-processing control program 194, and secures a setting information storage area 195, and a job storage area 196.

The control program 191 is a program that the controller 11 reads when generally controlling the multifunction peripheral 10. The controller 11 that reads the control program 191 controls driving of hardware such as the display 13, the operation inputter 15, the communicator 17, the image processor 21, the sheet conveyor 27, the post-processor 29, and the like.

The display control program 192 controls display of an operation screen displayed on the display 13 or the operation inputter 15 formed as a touch panel (for example, a home screen (not illustrated), a setting screen, an execution screen, or the like related to setting and execution of each job).

The job control program 193 is a program that the controller 11 reads when executing various jobs such as a print operation job including a copy job and a print job, a scan job, a fax job, and an e-mail sending job. The controller 11 that reads the job control program 193 sets an apparatus mode (operation mode) of the multifunction peripheral 10 to a job mode for executing each job (for example, a copy mode, a print mode, a scan mode, a fax mode, an e-mail sending mode, or the like), and executes a job for which an execution instruction is received.

The post-processing control program 194 is a program that the controller 11 reads when a print job in which post-processing for printouts is set by the user is received. For example, when the controller 11 that reads the post-processing control program 194 receives a division designation for printouts by the user as the post-processing, the controller 11 controls the sheet conveyor 27 to convey the printouts on which print images are formed to the post-processor 29. Then, the controller 11 performs the post-processing such as stapling processing in which a parameter based on the received division designation is used as a binding unit. Here, the division designation according to the disclosure refers to a setting to divide printouts using a predetermined division unit and perform the stapling processing.

The setting information storage area 195 is a storage area that stores apparatus setting information of the multifunction peripheral 10, setting information required for execution of a job, and the like.

The job storage area 196 is a storage area that stores a job for which an execution instruction is input by the user, and setting values and an execution status of an executed job as history information.

### 1.3 Regarding Terminal Device 50

The terminal devices 50a, 50b, and 50c can be configured as information processing apparatuses such as a smartphone, a notebook computer, a desktop computer, a tablet, and a mobile phone, for example. The terminal devices 50a, 50b, and 50c may have the same configuration, and thus will be described as the terminal device 50 in the following description.

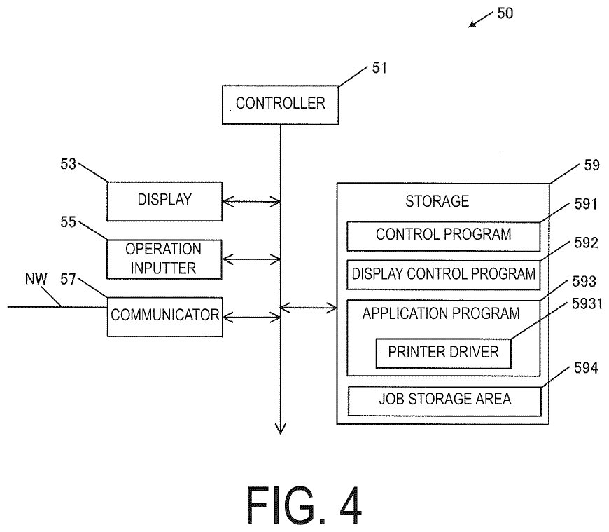

FIG. 4 is a functional configuration diagram of the terminal device 50. The terminal device 50 includes a controller 51, a display 53, an operation inputter 55, a communicator 57, and a storage 59.

The controller 51 generally controls the terminal device 50. The controller 51 can be formed of one or more processing apparatuses (for example, a CPU, an SoC, and the like). The controller 51 enables functions thereof by reading and executing various programs stored in the storage 59. Note that the controller 51 may be formed of one or more control circuits.

The display 53 displays various types of information to the user. The display 53 can include, for example, an LCD, an organic EL display, or the like. The display 53 can display various operation screens for text or diagram creation, and image editing, for example, based on display control by the controller 51 that reads an application program 593.

The operation inputter 55 receives information input from the user, or the like. Note that the operation inputter 55 can be configured as a touch panel display that enables input via the display 53, or may be an input device that enables information input such as a keyboard or a mouse.

The communicator 57 includes one or both of wired and wireless interfaces for communicating with other devices (the multifunction peripheral 10 and the like) via the network NW such as a LAN, a WAN, the Internet, a telephone line, or a fax line. Further, the communicator 57 may include an interface related to (short-range) wireless communication technology, such as Bluetooth (registered trademark), Near Field Communication (NFC), Wi-Fi (registered trademark), ZigBee (registered trademark), Infrared Data Association (IrDA), or wireless USB, for example.

The storage 59 is one or more storage devices that store various programs and various types of data necessary for operations of the terminal device 50. The storage 59 can be include by a storage device, such as a RAM, an SSD, an HDD, a ROM, or the like, for example.

In the first embodiment, the storage 59 stores a control program 591, a display control program 592 and the application program 593, and secures a job storage area 594.

The control program 591 is a program that the controller 51 reads when generally controlling the terminal device 50. The controller 51 that reads the control program 591 functions as an Operating System (OS) to control driving of hardware such as the display 53, the operation inputter 55, and the communicator 57.

The display control program 592 controls display of an operation screen (for example, an application screen, a print setting screen, or the like) displayed on the display 53 or the operation inputter 55 configured as a touch panel.

The application program 593 is, for example, various application programs to support, for example, text or diagram creation, image editing, and the like. The controller 51 that reads the application program 593 functions as an application and creates application data such as text, diagrams, and images.

Such an application program 593 may include a printer driver 5931. The printer driver 5931 is a driver program that cooperates with the application program 593 and receives print settings by the user via the print setting screen described below. The controller 51 that reads the printer driver 5931 outputs print data to cause the multifunction peripheral 10 to perform print output based on created application data and print settings set by the user. The output print data is transmitted to the multifunction peripheral 10 as a print job. The multifunction peripheral 10 can output a printout by performing printing based on the received print job.

The job storage area 594 is a storage area that stores print data generated via the printer driver 5931 as a print job.

### 1.4 Flow of Processing

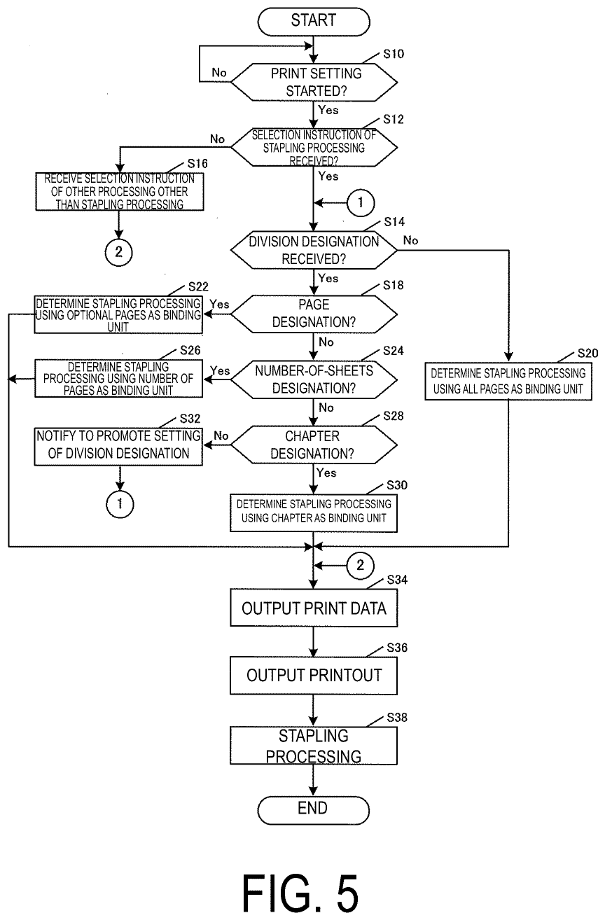

Next, a flow of processing according to the first embodiment will be described with reference to a flowchart illustrated in FIG. 5. FIG. 5 is a flowchart for explaining processing until a print job for which stapling processing is set is output in accordance with a print output instruction for application data created by a user. Note that main processing described in FIG. 5 is performed by the controller 51 of the terminal device 50 reading the control program 591, the display control program 592, the application program 593 (printer driver 5931), and the like.

When the processing is started, the controller 51 determines whether print setting is started or not (step S10). The controller 51 can determine whether the print setting is started or not by determining whether a print output instruction is input by the user via a print setting screen of an application or not.

When determining that the print setting is started, the controller 51 determines whether a selection instruction of stapling processing is received via the print setting screen or not (step S10; Yes->step S12). On the other hand, when determining that the print setting is not started, the controller 51 waits until the print setting is started (step S10; No).

When determining that the selection instruction of the stapling processing is received, the controller 51 determines whether a division designation for application data to be output as print data is received or not (step S12; Yes->step S14). Note that when determining that the selection instruction of the stapling processing is not received, the controller 51 receives a selection instruction for other processing other than the stapling processing (step S12; No->step S16). The controller 51 outputs print data based on print settings related to the other processing other than the stapling processing received in step S16 (step S34).

When determining in step S14 that the division designation is received, the controller 51 determines whether the division designation is a page designation to use optional pages of printouts corresponding to application data as the binding unit or not (step S14; Yes->step S18). On the other hand, when determining that the division designation is not received, the controller 51 determines that the stapling processing to be performed is the stapling processing in which all pages of the printouts are used as the binding unit, and transitions the processing to step S34 (step S14; No->step S20->step S34).

In step S18, when determining that the division designation is the page designation, the controller 51 determines that the stapling processing to be performed is the stapling processing in which the optional pages are used as the binding unit, and transitions the processing to step S34 (step S18; Yes->step S22->step S34).

On the other hand, when determining that the division designation is not the page designation, the controller 51 determines whether the division designation is a number-of-sheets designation in which an optional number of pages of the printouts is used as the binding unit or not (step S18; No->step S24).

In step S24, when determining that the division designation is the number-of-sheets designation, the controller 51 determines that the stapling processing to be performed is the stapling processing in which the number of pages is used as the binding unit, and transitions the processing to step S34 (step S24; Yes->step S26->step S34).

On the other hand, when determining that the division designation is not the number-of-sheets designation, the controller 51 determines whether the division designation is a chapter designation in which a chapter is used as the binding unit or not (step S24; No->step S28). In step S28, when determining that the division designation is the chapter designation, the controller 51 determines that the stapling processing to be performed is the chapter designation in which the chapter is used as the binding unit, and transitions the processing to step S34 (step S28; Yes->step S30->step S34).

On the other hand, when determining that the division designation is not the chapter designation, the controller 51 notifies the user to prompt the user to set a division designation, and returns the processing to step S14 (step S28; No->step S32->step S14).

In step S34, the controller 51 outputs the print data based on the print settings related to step S12 to step S30. Then, the controller 51 transmits the output print data as a print job to the multifunction peripheral 10.

The controller 11 of the multifunction peripheral 10 outputs a printout by printing a print image based on the received print job on a sheet (step S36). Then, the controller 11 of the multifunction peripheral 10 divides the printouts based on the set binding unit, and performs the stapling processing (step S38).

### 1.5 Operation Examples

Next, operation examples according to the first embodiment will be described. Note that a screen formation of the print setting screen to which the print setting method according to the disclosure is applied may have substantially the same configuration as the print setting screen W10 (W12) illustrated in FIGS. 18A and 18B. In the following description, a print setting item (“STAPLING” item) to receive selection of setting values (parameters) related to the stapling processing will be mainly described.

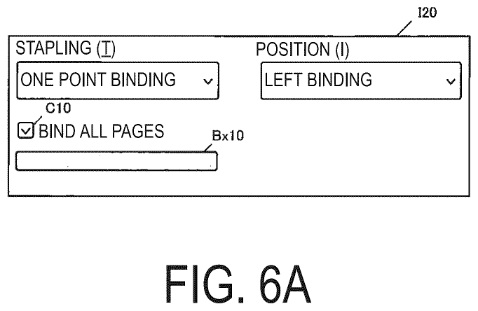

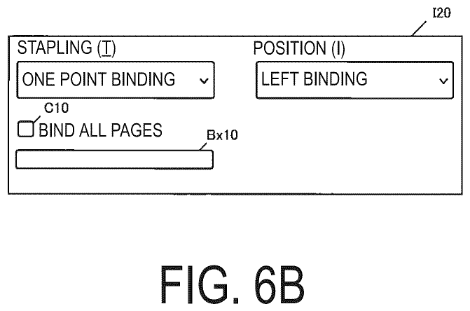

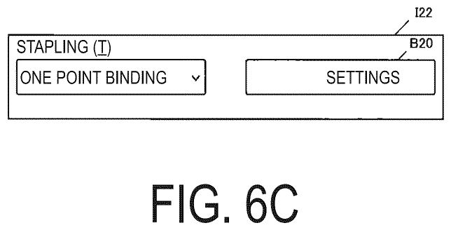

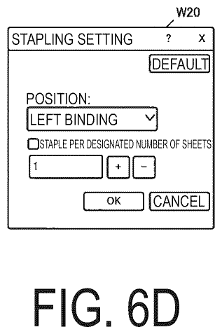

FIGS. 6A and 6B are diagrams for explaining a “stapling” item I20 according to the first embodiment as examples of the configuration. The “stapling” item I20 includes a “BIND ALL PAGES” checkbox C10 and a division parameter input box Bx10, in addition to the setting items related to the type of stapling (no stapling, one point binding, two-point binding, stapleless stapling, or the like) and the position of stapling (left binding, right binding, top binding, or the like) illustrated in FIG. 18A and the like.

The “BIND ALL PAGES” checkbox C10 is a checkbox to receive selection of the stapling processing in which all pages of printouts are used as a binding unit. As illustrated in FIG. 6A, when the user checks the “BIND ALL PAGES” checkbox C10, the controller 51 determines that the stapling processing to be performed is the stapling processing in which all the pages of the printouts are used as the binding unit. Note that the operation example is an operation example corresponding to the processing in step S14; No->step S20 in FIG. 5. When the “BIND ALL PAGES” checkbox C10 is checked, the controller 51 brings the input box Bx10 into an input disabled state such as a gray-out display so that input to the division parameter input box Bx10 is disabled.

On the other hand, as illustrated in FIG. 6B, when the “BIND ALL PAGES” checkbox C10 is not checked by the user, the division parameter input box Bx10 is in an active state, and input to the division parameter input box Bx10 is enabled. Note that the operation example is an operation example corresponding to the processing in step S14; Yes->step S30 in FIG. 5.

Incidentally, the “stapling” item I20 may be provided with a SETTINGS button B20 instead of the setting item related to the position of the stapling, as illustrated in FIG. 6C, for example. The SETTINGS button B20 is a selection button to receive a display instruction of a stapling setting screen W20 illustrated in FIG. 6D. The stapling setting screen W20 illustrated in FIG. 6D can include a checkbox to receive selection of the number-of-sheets designation in which the number of pages of printouts is used as a binding unit as the division designation, or the like, in addition to a setting item related to a position of the stapling. Note that the division designation that can be set on the stapling setting screen W20 is not limited to the number-of-sheets designation, and may be, for example, the page designation or the chapter designation (see FIG. 5).

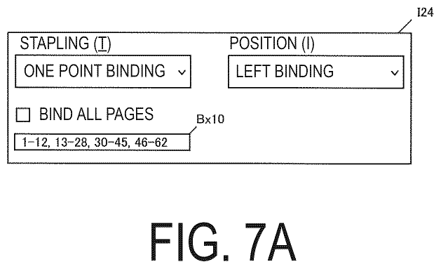

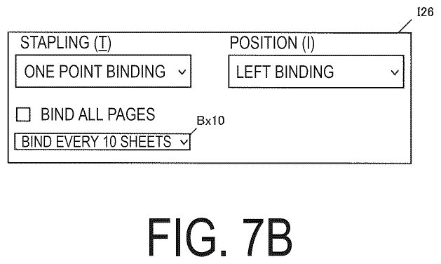

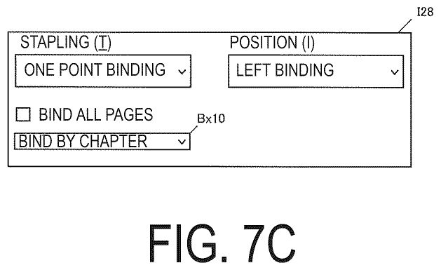

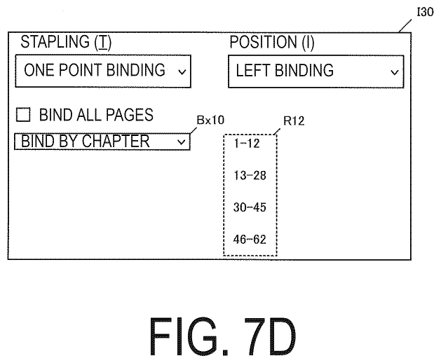

FIGS. 7A, 7B, 7C, and 7D are diagrams for explaining examples of input of setting values (parameters) corresponding to the respective division designation to the division parameter input box Bx10.

FIG. 7A is a diagram for explaining an example of input of a “stapling” item I24 when the division designation selected by the user is the page designation. Note that the operation example is an operation example corresponding to the processing in step S18; Yes->step S22 in FIG. 5. FIG. 7A illustrates a state where optional pages (pages 1-12, 13-28, 30-45, 46-62) of printouts are input as the page designation into the division parameter input box Bx10.

FIG. 7B is a diagram for explaining an example of input of a “stapling” item I26 when the division designation selected by the user is the number-of-sheets designation. Note that the operation example is an operation example corresponding to the processing in step S24; Yes->step S26 in FIG. 5. FIG. 7B illustrates a state where an optional number of pages of printouts (“BIND EVERY 10 SHEETS”) is input in the division parameter input box Bx10 as the number-of-sheets designation.

FIG. 7C is a diagram for explaining an example of input of a “stapling” item I28 when the division designation selected by the user is the chapter designation. Note that the operation example is an operation example corresponding to the processing in step S28; Yes->step S30 in FIG. 5. FIG. 7C illustrates a state where “BIND BY CHAPTER” is input in the division parameter input box Bx10 as the chapter designation.

Note that as illustrated in FIG. 7D, when the division designation selected by the user is the chapter designation, a page number display area R12 to display page numbers of each of chapters to divide may be provided. As illustrated in FIG. 7D, by displaying the page numbers for each of the chapters to divide, the user can easily grasp how printouts are divided by the chapters.

As described above, in the first embodiment, when printouts are divided and stapled, the division designation can be easily performed via the print setting screen such as the stapling processing in which optional pages of the printouts are used as the binding unit (page designation), the stapling processing in which an optional number of pages of the printouts is used as the binding unit (number-of-sheets designation), and the stapling processing in which a chapter that divides the printouts is used as the binding unit (chapter designation), in addition to the stapling processing in which all pages of the printouts are used as the binding unit (all page designation). Therefore, according to the first embodiment, the user can easily obtain printouts (booklets) bound using a desired division unit without dividing the printouts after printing output by himself/herself, and thus, convenience for the user can be further improved.

### 2. Second Embodiment

A second embodiment is a form in which, when information about a type of content (print content) forming a printout (for example, text, drawing, photograph, or the like) or a sheet size for print output as a printout can be acquired, it is possible to receive a division designation in which the type of print content or the sheet size is used as a binding unit.

A functional configuration according to the second embodiment can be substantially similar to the functional configuration according to the first embodiment. Accordingly, a description of the functional configuration according to the second embodiment will be omitted.

### 2.1 Flow of Processing

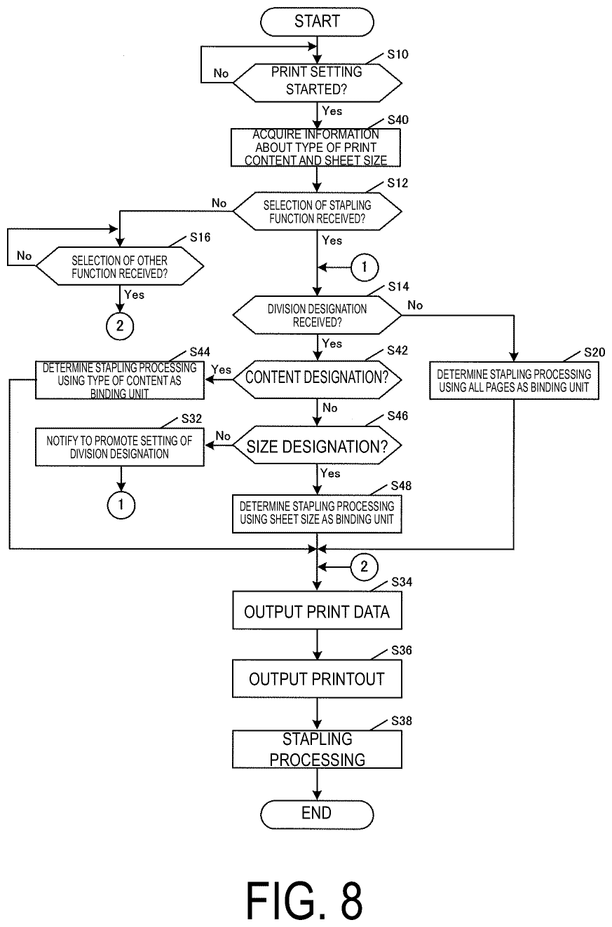

A flow of processing of the second embodiment can be obtained by replacing the flowchart in FIG. 5 with a flowchart in FIG. 8. Thus, steps at which the same processing as the processing according to FIG. 5 is performed are denoted by the same step numbers, and description thereof will be omitted. In addition, the controller 51 of the terminal device 50 according to the second embodiment will be described as being capable of acquiring information related to a type of print content or a sheet size to be output as a printout, but in this case, a form may be adopted in which the type of print content to be acquired is be fixed, or is automatically determined by the controller 51.

When determining in step S10 that print setting is started, the controller 51 of the terminal device 50 acquires information about a type of print content and sheet size, and performs processing in step S12 and subsequent steps (step S10; Yes->step S40->step S12).

When determining in step S14 that a division designation is received, the controller 51 determines whether the division designation is a content designation in which a print content is used as a binding unit or not (step S14; Yes->step S42). When determining that the division designation is the content designation, the controller 51 determines that the stapling processing to be performed is the stapling processing in which the type of print content is used as the binding unit, and transitions the processing to step S34 (step S42; Yes->step S44->step S34).

On the other hand, when determining that the division designation is not the content designation, the controller 51 determines whether the division designation is a size designation in which a sheet size of a sheet to be output as a printout is the binding unit or not (step S42; No->step S46). When determining that the division designation is the size designation, the controller 51 determines that the stapling processing to be performed is the stapling processing in which the sheet size is used as the binding unit, and transitions the processing to step S34 (step S46; Yes->step S48->step S34).

Note that when determining that the division designation is not the size designation, the controller 51 notifies the user to prompt the user to set a division designation, and returns the processing to step S14 (step S46; No->step S32->step S14).

### 2.2 Operation Examples

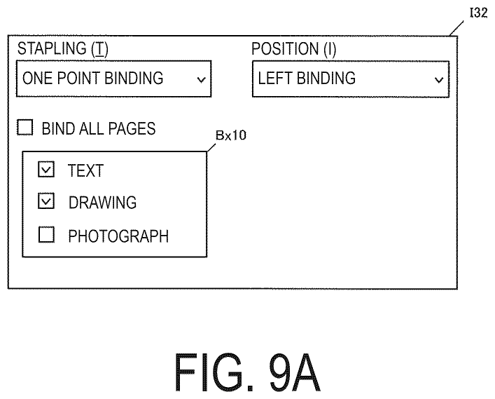

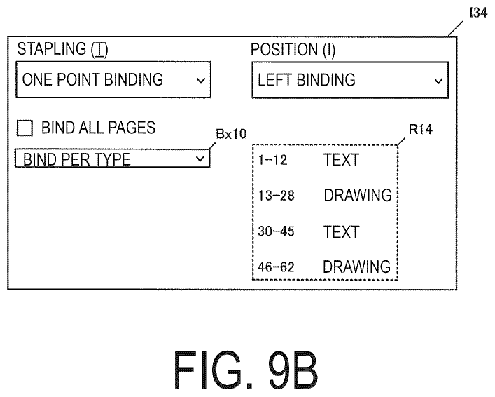

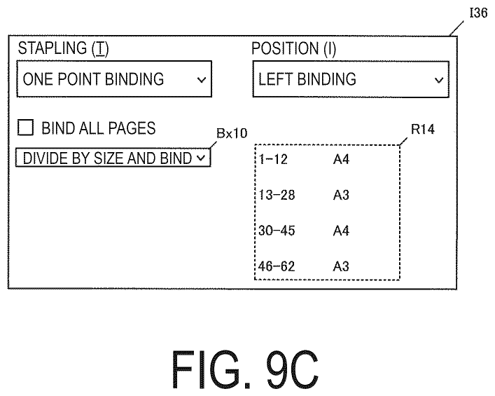

Next, operation examples according to the second embodiment will be described. FIG. 9A is a diagram for explaining an example of input of a “stapling” item I32 when the division designation selected by the user is the content designation. Note that the operation example is an operation example corresponding to the processing in step S42; Yes->step S44 in FIG. 8, and is an operation example when the type of print content to be acquired is fixed. FIG. 9A illustrates a state where TEXT and DRAWING are selected as the content designation in the division parameter input box Bx10.

On the other hand, similar to FIG. 9A, FIG. 9B is a diagram for explaining an example of input of a “stapling” item I34 when the division designation selected by the user is the content designation. FIG. 9B illustrates a case where the controller 51 proposes a division unit of printouts automatically determined according to a type of print content.

FIG. 9B illustrates a state where “BIND PER TYPE” is selected as the content designation in the division parameter input box Bx10. At this time, the controller 51 can also display the division unit of the printouts automatically determined according to the type of print content in a division unit display area R14. FIG. 9B illustrates that the stapling processing is proposed by the controller 51, in which printouts (pages 1-12) belonging to “TEXT”, printouts (pages 13-28) belonging to “DRAWING”, printouts (pages 30-45) belonging to “TEXT”, and printouts (pages 46-62) belonging to “DRAWING” are used as division units.

FIG. 9C is a diagram for explaining an example of input of a “stapling” item I36 when the division designation selected by the user is the size designation. Note that the operation example is an operation example corresponding to the processing in step S46; Yes->step S48 in FIG. 8. FIG. 9C illustrates a state where “DIVIDE BY SIZE AND BIND” is selected as the size designation in the division parameter input box Bx10. At this time, the controller 51 can also display a division unit of printouts automatically determined according to the sheet size in the division unit display area R14. FIG. 9C illustrates that the controller 51 proposes the stapling processing in which, for example, printouts (pages 1-12) belonging to “sheet size A4”, printouts (pages 13-28) belonging to “sheet size A3”, printouts (pages 30-45) belonging to “sheet size A4”, and printouts (pages 46-62) belonging to “sheet size A3” are used as division units.

As described above, according to the second embodiment, similarly to the effect according to the first embodiment, since it is possible to use the division designation in which the type of print content or the sheet size is used as the binding unit, it is possible to satisfy a request by a user who desires stapling based on the type of print content or the sheet size.

### 3. Third Embodiment

A third embodiment is a form in which a binding position related to the division designation is changed or designated in the first embodiment or the second embodiment.

A functional configuration according to the third embodiment can be substantially similar to the functional configuration according to the first embodiment or the second embodiment. Accordingly, a description of the functional configuration according to the third embodiment will be omitted.

### 3.1 Flow of Processing

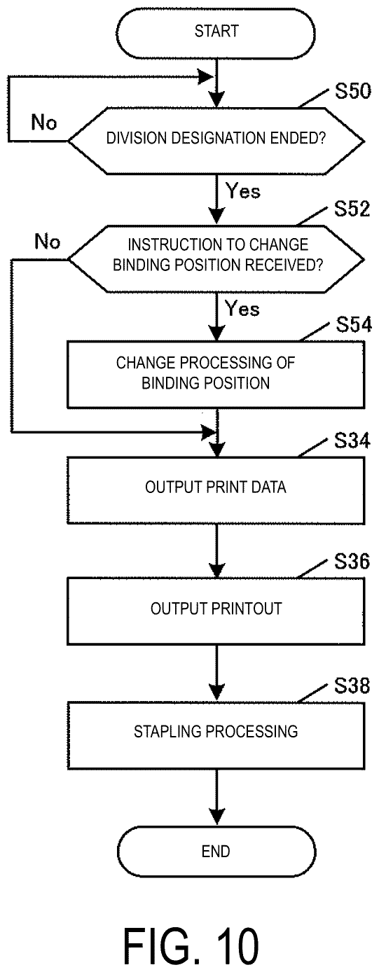

A flow of processing according to the third embodiment will be described using a flowchart in FIG. 10. Note that the processing described in FIG. 10 can be continuously performed after the processing in step S30 in FIG. 5 is ended in the first embodiment, and after the processing in step S48 in FIG. 8 is ended and after the processing related to the division designation is ended in the second embodiment. Therefore, in the flowchart in FIG. 10, the processing is started from processing of determining whether the processing related to the division designation is ended or not. Further, steps at which the same processing as the processing according to FIG. 5 or FIG. 8 is performed are denoted by the same step numbers, and description thereof will be omitted.

The controller 51 of the terminal device 50 determines whether the processing related to the division designation is ended or not (step S50). When determining that the processing related to the division designation is ended, the controller 51 determines whether an instruction to change a binding position of the stapling processing is received or not (step S50; Yes->step S52). On the other hand, when determining that the processing related to the division designation has not ended, the controller 51 waits until the processing related to the division designation is ended (step S50; No).

When determining that the instruction to change the binding position is received, the controller 51 performs processing related to the change of the binding position (step S52; Yes->step S54). On the other hand, when determining that the instruction to change the binding position is not received, the controller 51 omits the processing related to step S54 and transitions the processing to step S34 (step S52; No->step S34). The processing in step S34 and subsequent steps is the same processing as the processing described in FIG. 5 or FIG. 8, and thus the description thereof will be omitted here.

### 3.2 Operation Examples

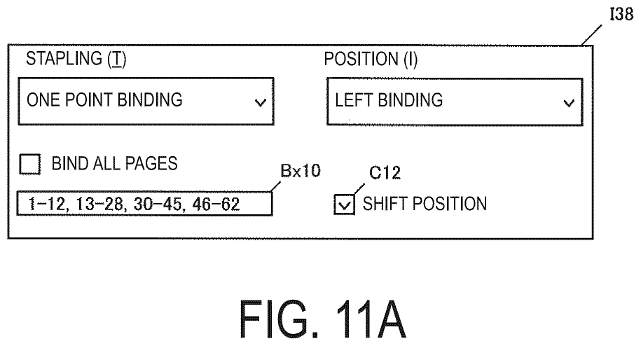

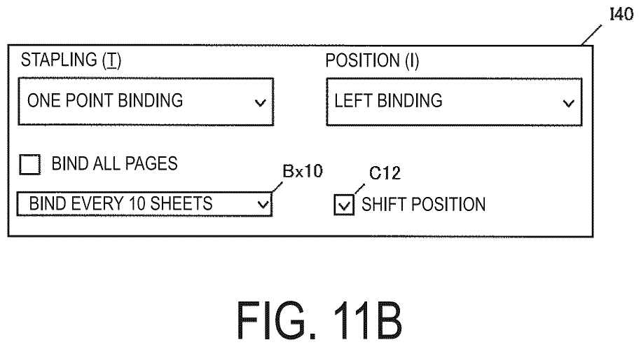

Next, operation examples according to the third embodiment will be described. FIG. 11A is a diagram for explaining an example of input of a “stapling” item I38 when the division designation selected by the user is the page designation. The “stapling” item I38 illustrated in FIG. 11A has the same configuration as the “STAPLING” item I24 illustrated in FIG. 7A, but is different in that a “SHIFT POSITION” checkbox C12 is included.

Similarly, FIG. 11B is a diagram for explaining an example of input of a “stapling” item I40 when the division designation selected by the user is the number-of-sheets designation. The “stapling” item I40 illustrated in FIG. 11B has the same configuration as the “stapling” item I26 illustrated in FIG. 7B, but is different in that the “SHIFT POSITION” checkbox C12 is included.

The “SHIFT POSITION” checkbox C12 is a selection button to receive an instruction to “shift” the binding position as an aspect related to change processing of the binding position of the stapling processing. When the user checks the “SHIFT POSITION” checkbox C12, the controller 51 outputs print data including an instruction to change the binding position, for example, to randomly shift a sheet within four sides of 5 mm when binding, or to shift the sheet in a fixed direction in steps of 2 mm when binding, and return the sheet to an original position when a shift width reaches 1 cm, and transmits the print data as a print job to the multifunction peripheral 10.

The multifunction peripheral 10 that receives the print job controls driving of a post-processor 29 to shift the sheet in vertical and horizontal directions, thereby changing the binding position of the stapling processing.

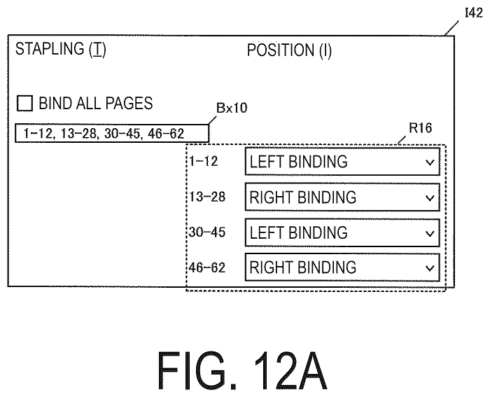

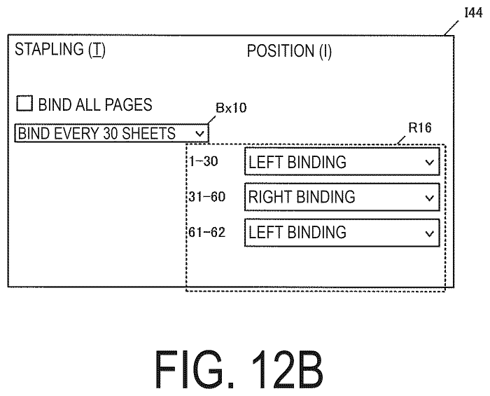

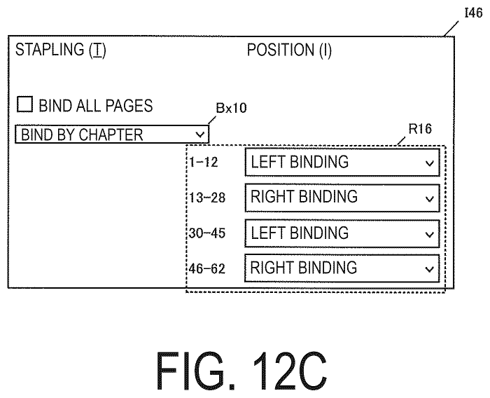

FIGS. 12A, 12B, and 12C are diagrams illustrating operation examples related to the designation of the binding position as another aspect related to the change processing of the binding position of the stapling processing. FIG. 12A is a diagram for explaining an example of input of a “stapling” item I42 when the division designation selected by the user is the page designation. The “stapling” item I42 illustrated in FIG. 12A has the same configuration as the “stapling” item I24 illustrated in FIG. 7A, but is different in that a binding position designation area R16 is included.

Similarly, FIG. 12B is a diagram for explaining an example of input of a “stapling” item I44 when the division designation selected by the user is the number-of-sheets designation. The “stapling” item I44 illustrated in FIG. 12B has the same configuration as the “stapling” item I26 illustrated in FIG. 7B, but is different in that the binding position designation area R16 is included.

Further, FIG. 12C is a diagram for explaining an example of input of a “stapling” item I46 when the division designation selected by the user is the chapter designation. The “stapling” item I46 illustrated in FIG. 12C has the same configuration as the “stapling” item I28 illustrated in FIG. 7C, but is different in that the binding position designation area R16 is included.

The binding position designation area R16 related to FIG. 12A to FIG. 12C is an area to receive the designation of the binding position of the stapling processing using the division unit set by the division designation. For example, the “stapling” item I42 illustrated in FIG. 12A illustrates that, optional pages (pages 1-12, 13-28, 30-45, and 46-62) of a document are input to the division parameter input box Bx10 as the page designation, and “LEFT BINDING” (pages 1-12), “RIGHT BINDING” (pages 13 to 28), “LEFT BINDING” (pages 30-45), and “RIGHT BINDING” (pages 46-62) are set as the binding positions for the respective division units.

Similarly, the “stapling” item I44 illustrated in FIG. 12B illustrates that, “BIND EVERY 30 SHEETS” is input to the division parameter input box Bx10 as the number-of-sheets designation, and “LEFT BINDING” (pages 1-30), “RIGHT BINDING” (pages 31-60), and “LEFT BINDING” (pages 61-62) are set as the binding positions for the respective division units.

Further, the “stapling” item I46 illustrated in FIG. 12C illustrates that, “BIND BY CHAPTER” is input to the division parameter input box Bx10 as the chapter designation, and “LEFT BINDING” (pages 1-12), “RIGHT BINDING” (pages 13-28), “LEFT BINDING” (pages 30-45), and “RIGHT BINDING” (pages 46-62) are set as the binding positions for the respective division units.

In FIG. 12A to FIG. 12C, the binding position designation area R16 to receive the designation of the binding position of the stapling processing using the division unit set by the division designation has been described. In addition, it is also possible to designate (designate and instruct) the type of stapling using the division unit set by the division designation.

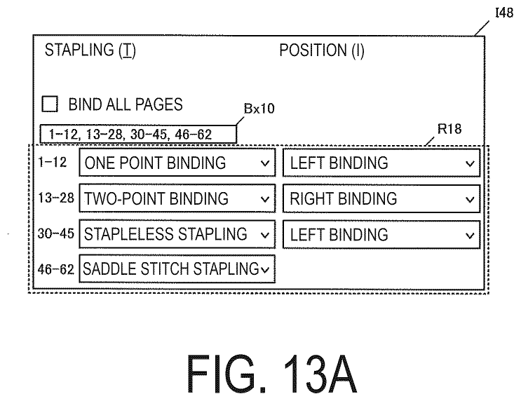

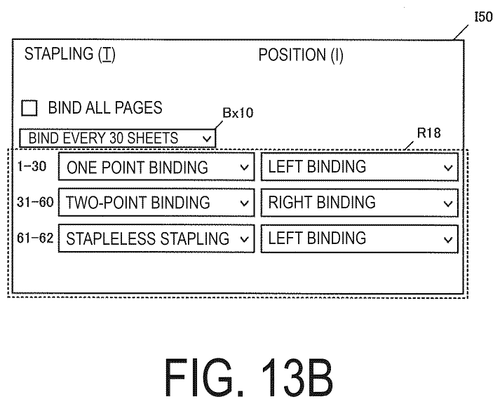

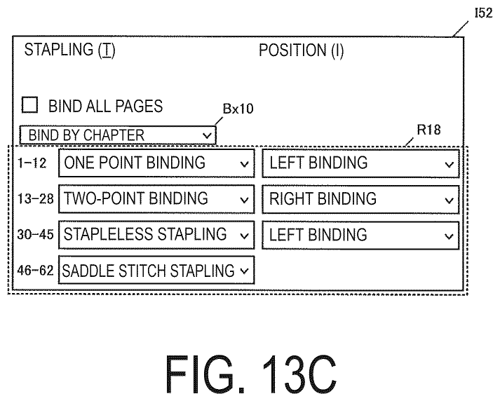

For example, FIG. 13A to FIG. 13C are diagrams for explaining examples of input of “stapling” items I48 to I52 provided with a stapling type/binding position designation area R18 instead of the binding position designation area R16 illustrated in FIG. 12A to FIG. 12C.

For example, the “stapling” item I48 illustrated in FIG. 13A illustrates that, optional pages (pages 1-12, 13-28, 30-45, and 46-62) of a document are input to the division parameter input box Bx10 as the page designation, and “ONE POINT BINDING and LEFT BINDING” (pages 1-12), “TWO-POINT BINDING and RIGHT BINDING” (pages 13-28), “STAPLELESS STAPLING and LEFT BINDING” (pages 30-45), and “SADDLE STITCH STAPLING” (pages 46-62) are set as the types of stapling and the binding positions for the respective division units.

Similarly, the “stapling” item I50 illustrated in FIG. 13B illustrates that “BIND EVERY 30 PAGES” is input to the division parameter input box Bx10 as the page designation, and “ONE POINT BINDING and LEFT BINDING” (pages 1-30), “TWO-POINT BINDING and RIGHT BINDING” (pages 31-60), and “STAPLELESS STAPLING and LEFT BINDING” (pages 61-62) are set as the types of stapling and the binding positions for the respective division units.

Further, similarly, the “stapling” item I52 illustrated in FIG. 13C illustrates that, “BIND BY CHAPTER” is input to the division parameter input box Bx10 as the chapter designation, and “ONE POINT BINDING and LEFT BINDING” (pages 1-12), “TWO-POINT BINDING and RIGHT BINDING” (pages 13-28), “STAPLELESS STAPLING and LEFT BINDING” (pages 30-45), and “SADDLE STITCH STAPLING” (pages 46-62) are set as the types of stapling and the binding positions for the respective division units.

As described above, according to the third embodiment, since a binding position can be changed in accordance with a division unit, it is possible to avoid divided printouts (booklets) from becoming bulky due to overlapping of binding positions of the stapling processing. Further, since a type of stapling can be designated together with a change in binding position, the convenience for the user can be further improved.

### 4. Fourth Embodiment

A fourth embodiment is a form in which, in the first embodiment or the second embodiment, when a remainder is generated when printouts are divided according to a division designation, it is possible to select whether to include (combine) a page corresponding to the remainder in a division unit immediately before the page corresponding to the remainder or not.

A functional configuration according to the fourth embodiment can be substantially similar to the functional configuration according to the first embodiment or the second embodiment. Accordingly, a description of the functional configuration according to the fourth embodiment will be omitted.

### 4.1 Flow of Processing

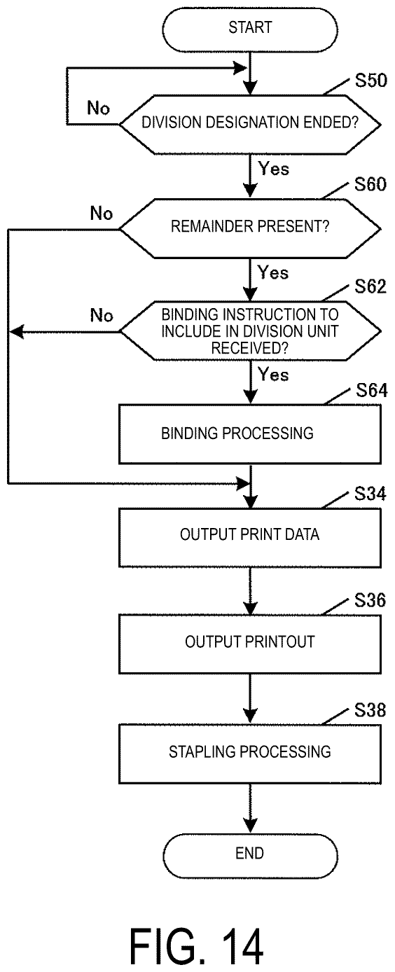

A flow of processing according to the fourth embodiment will be described using a flowchart in FIG. 14. Note that the processing described in FIG. 14 can be continuously performed after the processing in step S30 in FIG. 5 is ended in the first embodiment, and after the processing in step S48 in FIG. 8 is ended and after the processing related to the division designation is ended in the second embodiment. Therefore, in the flowchart in FIG. 14, the processing is started from the processing of determining whether the processing related to the division designation is ended or not. Further, steps at which the same processing as the processing according to FIG. 5, FIG. 8, or FIG. 10 is performed are denoted by the same step numbers, and description thereof will be omitted.

The controller 51 of the terminal device 50 determines whether the processing related to the division designation is ended or not (step S50). When determining that the processing related to the division designation is ended, the controller 51 determines whether a remainder is generated when printouts are divided according to the division designation or not (step S50; Yes->step S60). On the other hand, when determining that the processing related to the division designation has not ended, the controller 51 waits until the processing related to the division designation is ended (step S50; No).

When determining that the remainder is generated, the controller 51 determines whether a binding instruction to include a page corresponding to the remainder in a division unit immediately before the page corresponding to the remainder is received or not (step S60; Yes->step S62). When determining that the binding instruction is received, the controller 51 performs processing of including the page corresponding to the remainder in the previous division unit (binding processing) (step S62; Yes->step S64). When determining that the binding instruction is not received, the controller 51 omits the processing related to step S64 and transitions the processing to step S34 (step S62; No->step S34). The processing in step S34 and subsequent steps is the same processing as the processing described in FIG. 5 or FIG. 8, and thus the description thereof will be omitted here.

### 4.2 Operation Examples

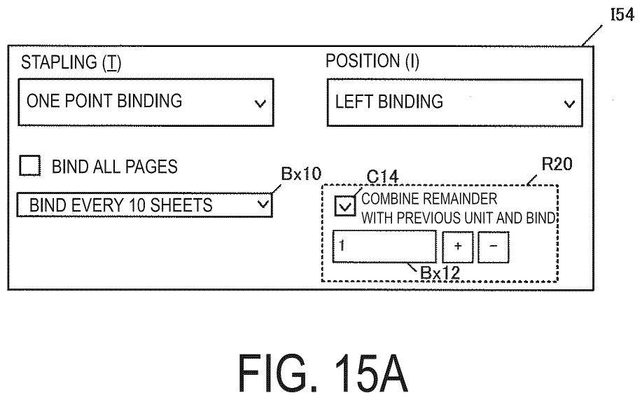

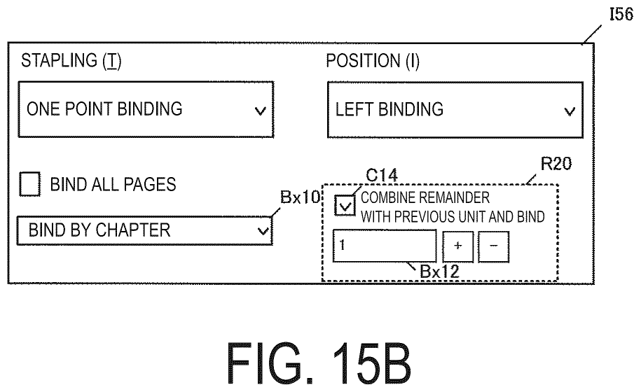

Next, operation examples according to the fourth embodiment will be described. FIG. 15A is a diagram for explaining an example of input of a “stapling” item I54 when the division designation selected by the user is the number-of-sheets designation. The “stapling” item I54 illustrated in FIG. 15A has the same configuration as the “stapling” item I26 illustrated in FIG. 7B, but is different in that a “combine and bind” setting area R20 is included.

Further, similarly, FIG. 15B is a diagram for explaining an example of input of a “stapling” item I56 when the division designation selected by the user is the chapter designation. The “stapling” item I56 illustrated in FIG. 15B has the same configuration as the “stapling” item I28 illustrated in FIG. 7C, but is different in that the “combine and bind” setting area R20 is included.

The “combine and bind” setting area R20 is a setting area to receive a setting when a remainder is generated when printouts are divided according to the division designation, to include a page corresponding to the remainder in a division unit immediately before the page corresponding to the remainder (combining setting). The “combine and bind” setting area R20 includes, for example, a “COMBINE REMAINDER WITH PREVIOUS UNIT AND BIND” checkbox C14 to receive a selection instruction of the combining setting by the user, and a number-of-sheets setting box Bx12 to receive a setting of the number of sheets (allowable number of sheets) of printouts (pages) to be combined with a division unit as a remainder. When the user checks the “COMBINE REMAINDER WITH PREVIOUS UNIT AND BIND” checkbox C14 and the remainder generated by the division designation is the number of sheets (or less) set in the number-of-sheets setting box Bx12, the controller 51 performs the binding processing of including the page corresponding to the remainder in the division unit immediately before the page corresponding to the remainder.

As described above, according to the fourth embodiment, even in a case where a remainder is generated when printouts are divided in accordance with a division designation, a page corresponding to the remainder is included in a division unit immediately before the page corresponding to the remainder, thereby satisfying a request of a user who does not want to leave printouts having the number of sheets being incomplete as a division unit.

### 5. Fifth Embodiment

A fifth embodiment is a form in which, in the first embodiment or the second embodiment, when the division designation is the number-of-sheets designation, an appropriate number of sheets to be bound is proposed according to a type of sheet (thick paper, plain paper, or the like) to be used to print a printout.

A functional configuration according to the fifth embodiment can be substantially similar to the functional configuration according to the first embodiment or the second embodiment. Accordingly, a description of the functional configuration according to the fifth embodiment will be omitted.

### 5.1 Flow of Processing

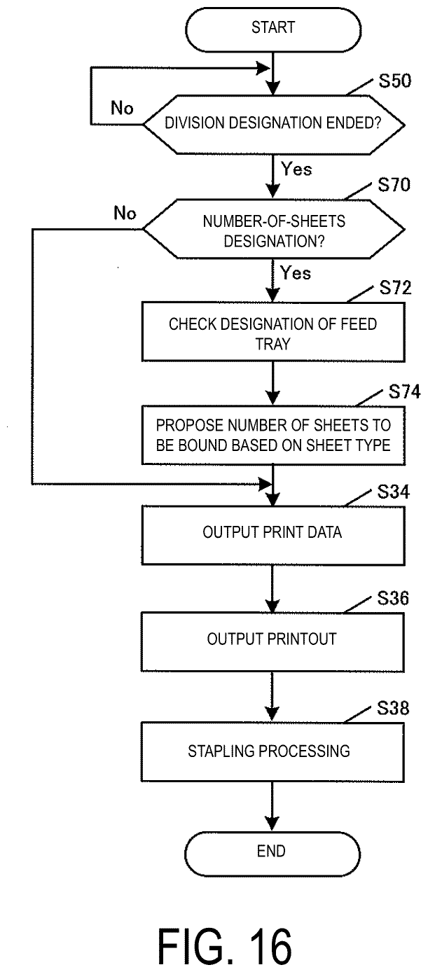

A flow of processing according to the fifth embodiment will be described using a flowchart in FIG. 16. Note that the processing described in FIG. 16 can be continuously performed after the processing in step S30 in FIG. 5 is ended in the first embodiment, and after the processing in step S48 in FIG. 8 is ended and after the processing related to the division designation is ended in the second embodiment. Therefore, in the flowchart in FIG. 16, the processing is started from the processing of determining whether the processing related to the division designation is ended or not. Further, steps at which the same processing as the processing according to FIG. 5, FIG. 8, FIG. 10, or FIG. 14 is performed are denoted by the same step numbers, and description thereof will be omitted.

The controller 51 of the terminal device 50 determines whether the processing related to the division designation is ended or not (step S50). When determining that the processing related to the division designation is ended, the controller 51 determines whether the division designation is the number-of-sheets designation or not (step S50; Yes->step S70). On the other hand, when determining that the processing related to the division designation has not ended, the controller 51 waits until the processing related to the division designation is ended (step S50; No).

When determining that the division designation is the number-of-sheets designation, the controller 51 checks a designation status of a feed tray to feed a sheet to be used to print a printout (step S70; Yes->step S72). Next, the controller 51 proposes an appropriate number of sheets to be bound related to printout division based on a sheet type of the sheet accommodated in the feed tray designated for printing (step S74).

On the other hand, when determining that the division designation is not the number-of-sheets designation, the controller 51 omits the processing related to step S72 and step S74 and transitions the processing to step S34 (step S70; No->step S34). The processing in step S34 and subsequent steps is the same processing as the processing described in FIG. 5 or FIG. 8, and thus the description thereof will be omitted here.

### 5.2 Operation Examples

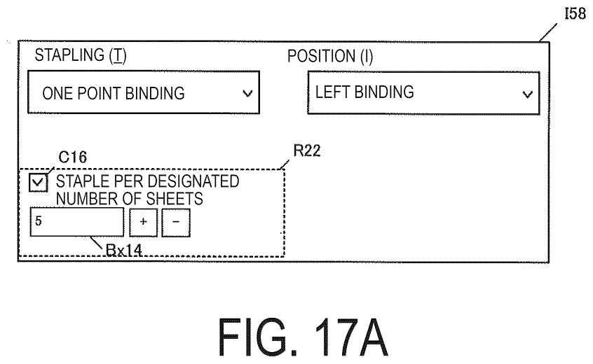

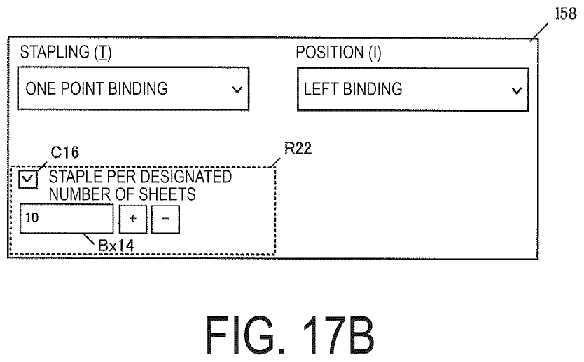

Next, operation examples according to the fifth embodiment will be described. FIG. 17A and FIG. 17B are diagrams for explaining examples of input of a “stapling” item I58 according to the fifth embodiment. The “stapling” item I58 illustrated in FIG. 17A and FIG. 17B has substantially the same configuration as the “stapling” item I20 illustrated in FIG. 6B, but is different in that a “proposal of the number of sheets to designate” area R22 is included.

Here, the “proposal of the number of sheets to designate” area R22 includes a “STAPLE PER DESIGNATED NUMBER OF SHEETS” checkbox C16 to receive a selection instruction of a designated number of sheets as the division designation, and a proposal of the number of sheets display box Bx14.

The “proposal of the number of sheets to designate” area R22 is an area to propose an appropriate number of sheets to be bound related to printout division based on a sheet type of the sheet accommodated in a feed tray designated for printing. When the user checks the “STAPLE PER DESIGNATED NUMBER OF SHEETS” checkbox C16, the controller 51 displays the number of sheets to be bound calculated based on the sheet type in the proposal of the number of sheets display box Bx14. For example, when the sheet type is thick paper, the controller 51 calculates the number of sheets to be bound to be smaller than that when the sheet type is plain paper, and proposes a result of the calculation to the user.

For example, FIG. 17A illustrates a proposal result of the number of sheets to be bound when thick paper is accommodated in the designated feed tray, and FIG. 17B illustrates a proposal result of the number of sheets to be bound when plain paper is accommodated in the designated feed tray. As illustrated in FIG. 17A and FIG. 17B, it is understood that the controller 51 proposes the number of sheets to be bound (thick paper) in FIG. 17A smaller than the number of sheets to be bound (plain paper) proposed in FIG. 17B.

As described above, according to the fifth embodiment, the stapling processing can be performed with an appropriate number of sheets to be bound according to a type of the sheet accommodated in a feed tray designated in the multifunction peripheral 10.

The disclosure is not limited to the above-described embodiments, and various modifications can be made. In other words, the technical scope of the disclosure also includes embodiments obtained by combining technical means that are appropriately modified within the scope of the gist of the disclosure.

Further, although the above-described embodiments are described separately for convenience of description, it is obvious that the embodiments may be executed in combination within a technically possible scope.

Further, in the embodiments, a program operating on each apparatus is a program that controls a CPU or the like (a program for causing a computer to function) to enable the functions of the above-described embodiments. In addition, information handled by these devices is temporarily accumulated in a transitory storage device (e.g., a RAM) at the time of processing, is then stored in a storage device such as any of various ROMs or HDDs, and is read, corrected, and written by the CPU as needed.

Here, a computer-readable non-transitory recording medium on which a program is recorded in an information processing apparatus may be any of a semiconductor medium (for example, a ROM or a non-volatile memory card), an optical recording medium/magnetic optical recording medium (for example, a Digital Versatile Disc (DVD), Magneto Optical disc (MO), Mini Disc (MD), Compact Disc (CD), or Blu-ray (BD; registered trademark) disc), a magnetic recording medium (for example, a magnetic tape or flexible disk), and the like. In this case, the program recorded on the recording medium is read by the computer of the information processing apparatus and executed by the computer, such that not only the functions of the above-described embodiment are enabled, but also functions of the disclosure are enabled by performing processing in cooperation with an operating system, another application program, or the like based on instructions of the program.

Further, when a program is distributed in a market, the program can be stored in a portable recording medium and distributed, or can be transferred to a server computer connected via a network such as the Internet. In this case, it is obvious that a storage device of the server computer is also included in the disclosure.

Further, each functional block or feature of the apparatus used in the above-described embodiment can also be implemented and executed by an electric circuit, such as an integrated circuit or a plurality of integrated circuits. The electric circuit designed to enable the functions described herein may include a general-purpose processor, a Digital Signal Processor (DSP), an Application-Specific Integrated Circuit (ASIC), a Field Programmable Gate Array (FPGA), another programmable logic device, a discrete gate or transistor logic, a discrete hardware component, or a combination thereof. The general-purpose processor may be a microprocessor, or any known processor, controller, microcontroller, or state machine. The electric circuit described above may include a digital circuit or may include an analog circuit. Further, when an integrated circuit technology for replacement into a current integrated circuit emerges with the development of semiconductor technology, a new integrated circuit based on the technology may also be used in one or more aspects of the disclosure.

What is claimed is:

1. A print setting method for a processing apparatus that performs stapling processing for one or more printouts, comprising:
(a) receiving a designation of the stapling processing for the one or more printouts; and
(b) outputting, in a case where a division designation to divide and bind the one or more printouts in step (a) is received, the one or more printouts using a division unit according to the division designation received.

2. The print setting method according to claim 1, wherein
step (a)
receives the division designation in which a page designation to designate an optional page forming the one or more printouts, a number-of-sheets designation to designate the number of sheets of pages, or a chapter designation to designate a chapter in a case where the one or more printouts are divided by the chapter is used as the division unit.

3. The print setting method according to claim 1, wherein
step (a)
receives the division designation in which a content designation to designate a type of content forming the one or more printouts, and a size designation to designate a size of a medium forming the one or more printouts is used as the division unit.

4. The print setting method according to claim 1, wherein
step (a)
receives a change instruction to change a binding position of stapling for each the division unit.

5. The print setting method according to claim 4, wherein
step (a)
receives a designation instruction to designate a type of stapling for each the division unit.

6. The print setting method according to claim 1, wherein
step (a)
in a case where the one or more printouts are divided according to the division designation and a remainder is generated, includes, in the division unit immediately before a page corresponding to the remainder, the page.

7. The print setting method according to claim 2, wherein
further includes (c) proposing the number of sheets designation to a user according to a type of medium to be used for printing of print data.

8. A printing apparatus that outputs one or more printouts based on a print setting received via a driver program of a terminal device, the printing apparatus comprising:
one or more controllers that receive a designation of stapling processing for the one or more printouts included in the print setting; and
a printer, wherein
in a case of receiving a division designation to divide and bind the one or more printouts, the one or more controllers cause the printer to output the one or more printouts using a division unit according to the division designation received.

9. A printing apparatus, comprising:
one or more controllers that receive a designation of stapling processing for one or more printouts; and
a printer, wherein
in a case of receiving a division designation to divide and bind the one or more printouts, the one or more controllers cause the printer to output the one or more printouts using a division unit according to the division designation received.
